(19) United States
(12) Patent Application Publication
(10) Pub. No.: US 2022/0242217 A1
(43) Pub. Date: Aug. 4, 2022

(54) A MODULAR TRANSMISSION PLATFORM AND A POWERTRAIN FOR A VEHICLE

(71) Applicant: Scania CV AB, Södertälje (SE)

(72) Inventors: Stefan KARLSSON, Stallarholmen (SE); Jörgen FORSBERG, Mariefred (SE); Tomas LÖFWALL, Årsta (SE); Christian NESS, Nykvarn (SE)

(73) Assignee: Scania CV AB, Södertälje (SE)

(21) Appl. No.: 17/617,534

(22) PCT Filed: Jun. 2, 2020
(86) PCT No.: PCT/SE2020/050554

§ 371 Date: Dec. 8, 2021

(30) Foreign Application Priority Data
Jun. 18, 2019 (SE) 1950739-1

(51) Int. Cl. B60K 6/36; B60K 6/547

(52) U.S. Cl. CPC B60K 6/36; B60K 6/48; B60K 6/547

(57) ABSTRACT

Disclosed is a modular transmission platform for a vehicle. The modular transmission platform comprises a first transmission shaft with at least one input shaft configured to be connected to at least one propulsion unit, a second transmission shaft rotatably connected to the first transmission shaft via a first transmission unit, and a third transmission shaft with a first output shaft configured to be connected to a propeller shaft. The third transmission shaft is rotatably connected to the second transmission shaft via a second transmission unit. The modular transmission platform comprises at least one second output shaft, configured for providing torque to equipment connected to the at least one second output shaft. The at least one input shaft and the first output shaft extend from the modular transmission platform in the same direction.

### CROSS-REFERENCE TO RELATED APPLICATIONS

This application is a National Stage Patent Application (filed under 35 § U.S.C. 371) of PCT/SE2020/050554, filed Jun. 2, 2020 of the same title, which, in turn claims priority to Swedish Patent Application No. 1950739-1 filed Jun. 18, 2019 of the same title; the contents of each of which are hereby incorporated by reference.

### FIELD OF THE INVENTION

The invention relates to a modular transmission platform for a vehicle according to the appended claims. The invention further relates to a powertrain for a vehicle according to the appended claims. The invention further relates to a vehicle according to the appended claims.

### BACKGROUND OF THE INVENTION

Heavy vehicles, such as trucks and busses, may be propelled by means of internal combustion engines. In order to reduce the consumption and dependence on fossil fuels, hybrid powertrains have been developed. A hybrid powertrain typically combine the use of a main propulsion unit, such as an internal combustion engine, with a secondary propulsion unit, such as an electric motor driven by a battery. In order to completely avoid using fossil fuels, all-electric vehicles have been developed. All-electric vehicles are propelled by means of at least one electrical machine/electric motor.

Document US 2011/0212803 A1 discloses a drive for an electric vehicle, comprising a first electric motor, a second electric motor and a planetary gear train coupling the first and second electric motors.

The operating range of the vehicle may be extended if the fuel or electric power supply of the vehicle is large. Fuel is stored in energy storage units, such as fuel tanks of the vehicle. Electrical power is stored in energy storage units of the vehicle. The energy storage units are arranged on the vehicle, so that they do not end up in conflict with other components on the vehicle. There are electric vehicles, which comprises receiving portions for energy storage units on side portions of the vehicle and between front and rear wheels.

### SUMMARY OF THE INVENTION

Due to different needs of the user of a heavy vehicle, the gearbox and the powertrain of the vehicle often is adapted to the specific need of the user of a heavy vehicle. If the vehicle is used as a commercial transport vehicle on roads, such as motorways, the gearbox and the powertrain should be adapted drive the vehicle mainly on constant and high speeds. If the vehicle is used as a commercial vehicle in cities with dense traffic with frequent brakes and accelerations, the gearbox and the powertrain should be adapted for frequent brakes and accelerations of the vehicle.

Vehicles with hybrid powertrains and all-electric vehicles may require power for Power Take Offs (PTO) or auxiliary components, such as air compressors or climate systems. Depending on the users need, such vehicles may comprise electrical machines and/or internal combustion engines configured for providing the required power to such Power Take Offs and auxiliary components. Such vehicles may also comprise a gearbox and a powertrain adapted for the users need.

A vehicle, which only propulsion unit is an electrical machine, the storage of energy storage units and the capacity of the energy storage units are critical for the operation range of the vehicle. A large energy storage unit or a number of small energy storage units require space in the vehicle. In addition, a vehicle comprises components such as shafts, frames, and components in the powertrain, which restrict the possibility to arrange large energy storage units on the vehicle. If the propulsion unit also comprises an internal combustion engine, additional storage of fuel in the energy storage unit, such as a fuel tank is required. Arranging a conventional powertrain rearwards in the vehicle in a direction towards a rear axle for rear drive wheels of the vehicle may not satisfactory create more space in front of the propulsion unit. Since the length of a propeller shaft of the powertrain will decrease to a critical length and joint angles will exceed the maximum allowable angle both in normal driving position and at rear axle movements when arranging the conventional powertrain rearwards, the space in front of the powertrain and behind the front axle will be restricted.

Therefore, it is desired to develop a modular transmission platform and a powertrain for a vehicle, which cover a wide specification of performance steps for different vehicles.

Further, it is desired to develop a modular transmission platform and a powertrain for a vehicle, which is configured to provide specific power and torque to equipment, which is external in relation to the powertrain.

Further, it is desired to arrange a modular transmission platform and a powertrain for a vehicle in a position that a space is created for accommodating energy storage units.

Further, it is desired to develop a modular transmission platform, which is adaptable for heavy vehicle applications.

An object of the invention is therefore to develop a modular transmission platform and a powertrain for a vehicle, which cover a wide specification of performance steps for different vehicles.

A further object of the invention is to develop a modular transmission platform and a powertrain for a vehicle, which is configured to provide specific power and torque to equipment, which is external in relation to the powertrain.

A further object of the invention is to arrange a modular transmission platform and a powertrain for a vehicle in a position that a space is created for accommodating energy storage units.

A further object of the invention is to develop a modular transmission platform and a powertrain, which is adaptable for heavy vehicle applications.

The herein mentioned objects are achieved with a modular transmission platform for a vehicle according to the appended claims. The herein mentioned objects are also achieved with a powertrain for a vehicle according to the appended claims. The herein mentioned objects are also achieved with a vehicle according to the appended claims.

According to an aspect of the invention, a modular transmission platform for a vehicle is provided. The modular transmission platform comprising: a first transmission shaft with at least one input shaft configured to be connected to at least one propulsion unit; a second transmission shaft, which is rotatably connected to the first transmission shaft via a first transmission unit; and a third transmission shaft with a first output shaft configured to be connected to a propeller shaft; wherein the third transmission shaft is rotatably connected to the second transmission shaft via a second transmission unit; wherein the modular transmission platform comprises at least one second output shaft, configured for providing torque to equipment connected to the at least one second output shaft; and wherein the at least one input shaft and the first output shaft extend from the modular transmission platform in the same direction.

Such modular transmission platform will cover a wide specification of performance steps for different vehicles. In addition, the first and second transmission units will provide a wide specification of performance steps in the vehicle. Equipment, which is external of the modular transmission platform, may be provided with torque from the at least one second output shaft. Since the at least one input shaft and the first output shaft extend from the modular transmission platform in the same direction it is possible to create a space in front of the modular transmission platform for accommodating energy storage units.

According to a further aspect of the invention, a powertrain for a vehicle is provided. The powertrain, comprising the modular transmission platform disclosed herein.

Such powertrain will provide a wide specification of performance steps due to the first and second transmission units of the powertrain. The powertrain will be able to provide external equipment with torque from the at least one second output shaft of the modular transmission platform. Since the at least one input shaft and the first output shaft extend from the modular transmission platform in the same direction, a large amount of energy storage units may be accommodated in a space created in front of the powertrain. Such energy storage units may provide electric power and/or fuel to propulsion units in the vehicle. The created space in front of the powertrain may accommodate a large energy storage unit or a number of small energy storage units. Vehicle components such as shafts, frames, and components in the powertrain will be arranged outside the created space for the energy storage units. By arranging a propulsion unit in a position between the modular transmission platform and the rear axle in the longitudinal direction of the vehicle will create an essential space in front of the powertrain. Further, when arranging the powertrain rearwards in the vehicle in a direction towards rear axle of the vehicle, the created space in front of the powertrain will be even larger.

According to a further aspect of the invention, a vehicle is provided. The vehicle, comprising the powertrain disclosed herein.

Such vehicle will have a wide specification of performance steps due to the powertrain comprising the first and second transmission units arranged in the vehicle. The vehicle will be able to provide external equipment with torque from the powertrain comprising the at least one second output shaft of the modular transmission platform. Since the at least one input shaft and the first output shaft in the powertrain extend from the modular transmission platform in the same direction, the vehicle will accommodate a large amount of energy storage units in a space created in front of the powertrain. Such energy storage units may provide electric power and/or fuel to propulsion units in the vehicle. The created space in the vehicle may accommodate a large energy storage unit or a number of small energy storage units. Vehicle components such as shafts, frames, and components in the powertrain will be arranged outside the created space for the energy storage units. By arranging a propulsion unit in a position between the modular transmission platform and the rear axle in the longitudinal direction of the vehicle will create an essential space in front of the powertrain. Further, when arranging the powertrain rearwards in the vehicle in a direction towards rear axle of the vehicle, the created space in front of the powertrain will be even larger.

Additional objectives, advantages and novel features of the invention will be apparent to one skilled in the art from the following details, and through exercising the invention. While the invention is described below, it should be apparent that the invention may not be limited to the specifically described details. One skilled in the art, having access to the teachings herein, will recognize additional applications, modifications and incorporations in other areas, which are within the scope of the invention.

### BRIEF DESCRIPTION OF THE DRAWINGS

For fuller understanding of the present disclosure and further objects and advantages of it, the detailed description set out below should be read together with the accompanying drawings, in which the same reference notations denote similar items in the various figures, and in which:

FIG. 1 schematically illustrates a side view of a vehicle with a powertrain according to an example;

FIG. 2 schematically illustrates a view from above of a vehicle with a powertrain according to an example; and

FIGS. 3a-3c schematically illustrate views from above of powertrains according to different examples.

### DETAILED DESCRIPTION OF THE INVENTION

The modular transmission platform and the powertrain according to the present disclosure may be arranged in a position in a vehicle such that a space is created for accommodating energy storage units in the vehicle. Since the at least one input shaft and the first output shaft extend from the modular transmission platform in the same direction it is possible to create a space in front of the modular transmission platform in the powertrain for accommodating energy storage units. The first and second transmission units arranged between the first and second transmission shafts, and the second and third transmission shafts results in a modular transmission platform, which will cover a wide specification of performance steps for different vehicles. In addition, the first and second transmission units will also provide a wide specification of performance steps in the vehicle, in which the modular transmission platform is arranged. Equipment, which is external of the powertrain, may be provided with torque from the at least one second output shaft of the modular transmission platform.

According to the present disclosure, a modular transmission platform for a vehicle is provided. The modular transmission platform comprising: a first transmission shaft with at least one input shaft configured to be connected to at least one propulsion unit; a second transmission shaft, which is rotatably connected to the first transmission shaft via a first transmission unit; and a third transmission shaft with a first output shaft configured to be connected to a propeller shaft; wherein the third transmission shaft is rotatably connected to the second transmission shaft via a second transmission unit; and wherein the modular transmission platform comprises at least one second output shaft, configured for providing torque to equipment connected to the at least one second output shaft; and wherein the at least one input shaft and the first output shaft extend from the modular transmission platform in the same direction.

The modular transmission platform in the vehicle transfers power from the propulsion unit to drive wheels of the vehicle. The vehicle may be a heavy vehicle, e.g. a truck or a bus. The vehicle may alternatively be a passenger car. The vehicle may be driven by a driver. The vehicle may be remotely operated or autonomously operated. The drive wheels may be arranged in a rear part of the vehicle or in a front part of the vehicle. All wheels of the vehicle may be drive wheels. The propulsion unit may comprise one or several electrical machines. Alternatively, the propulsion unit may be an internal combustion engine. It is also possible to combine one or several electrical machines with an internal combustion engine and connect them to the modular transmission platform. Such combination may allow the electrical machines and the internal combustion engine to work independently of each other or to work in combination as a hybrid drive.

The modular transmission platform may comprise gear wheels for transferring torque and gear ratio. The modular transmission platform may comprise a chain or a belt transmission for transferring torque and gear ratio. The gear ratio over the modular transmission platform is variable. The modular transmission platform may be automatically or a manually controlled. The modular transmission platform may comprise an automatic-manual-transmission, such as an AMT gearbox.

The propeller shaft is configured to transfer rotational motion and torque between the modular transmission platform and at least one drive shaft of a rear axle. The propeller shaft is with a first end connected to the first output shaft of the modular transmission platform and with a second end connected to the at least one drive shaft. The second end of the propeller shaft may be connected to the at least one drive shaft via a differential gear, which is arranged in the rear axle. The differential gear comprises an input shaft, which is connected to the propeller shaft, and two output shafts, each connected to a drive shaft. Each drive shaft is connected to a drive wheel, for driving the vehicle. The at least one drive shaft is configured to transfer rotational motion and torque between the propeller shaft and the drive wheel. The propeller shaft may have an extension in the same direction as the extension of the first output shaft of the modular transmission platform and the extension of the input shaft of the differential gear. However, the propeller shaft may have an extension in another direction than the extension of the first output shaft of the modular transmission platform and the extension of the input shaft of the differential gear. The rear axle may have an extension from one rear drive wheel at one side of the vehicle to another drive wheel on the other side of the vehicle. The vehicle may comprise a frame. The modular transmission platform may be connected or attached to the frame. Thus, the propulsion unit, modular transmission platform, and the rear axle may be connected or attached to the frame. The rear axle may be connected to the frame by means of a suspension, which allows the rear axle to move in a vertical direction in relation to the extension of the frame.

The at least one propulsion unit may be arranged in a position between the modular transmission platform and the rear axle in a longitudinal direction of the vehicle. Further, the at least one propulsion unit is positioned in parallel with the first output shaft of the modular transmission platform and the propeller shaft. In front of the modular transmission platform a space is created when the at least one propulsion unit is arranged in a position between the modular transmission platform and the rear axle. The definition of the longitudinal direction of the vehicle, is a direction from the front part of the vehicle to the rear part of the vehicle. The created space in front of the modular transmission platform may accommodate energy storage units for storing electrical power. The created space may alternatively, or in combination, accommodate energy storage units for liquid fuel, such as diesel fuel or petrol.

The created space for accommodating energy storage units increases the storage and the capacity of electrical power and/or liquid fuel for propulsion of the propulsion units, and thus increases the operation range of the vehicle. The created space in the vehicle may accommodate a large energy storage unit or a number of small energy storage units.

Vehicle components such as shafts, frames, and components in the powertrain will be arranged outside the created space for the energy storage units. Thus, by arranging the at least one propulsion unit in a position between the modular transmission platform and the rear axle in the longitudinal direction of the vehicle will create an essential space in front of the modular transmission platform. Further, when arranging the modular transmission platform rearwards in the vehicle in a direction towards rear axle of the vehicle, the created space in front of the modular transmission platform will be even larger.

The first transmission shaft is driven by the propulsion unit. If a number of propulsion units are connected to the first transmission shaft, the first transmission shaft is driven by these propulsion units. A first propulsion unit may be connected to the input shaft. A second propulsion unit may be connected to another input shaft. Both input shafts are connected to the first transmission shaft. If the propulsion unit is an electrical machine, which may also configured as a generator, the electrical machine may be driven by the first transmission shaft in order to generate electric power to the energy storage unit.

The second transmission shaft is driven by the first transmission shaft. However, the first transmission shaft may be driven by the second transmission shaft under circumstances when the electrical machine should be driven as a generator for generating electrical power. The first transmission unit is arranged between the first and the second transmission shaft. The first transmission unit may be a gearbox, comprising gear wheels for transferring torque and gear ratio between the first and the second transmission shafts. The first transmission unit may be a gearbox, comprising a chain or a belt transmission for transferring torque and gear ratio. The gear ratio over the first transmission unit may be fixed or variable. The gear ratio may be 1:1.

The third transmission shaft is driven by the second transmission shaft. However, the second transmission shaft may be driven by the third transmission shaft under circumstances when the electrical machine should be driven as a generator for generating electrical power. The second transmission unit is arranged between the second and the third transmission shafts. The second transmission unit may be a gearbox comprising gear wheels for transferring torque and gear ratio between the second and the third transmission shafts. The second transmission unit may be a gearbox, comprising a chain or a belt transmission for transferring torque and gear ratio. The gear ratio over the first transmission unit may be fixed or variable. The gear ratio may be 1:1.

Since the at least one input shaft and the first output shaft extend from the modular transmission platform in the same direction it is possible to create a space in front of the modular transmission platform for accommodating energy storage units.

Equipment, which is external of the modular transmission platform, may be provided with torque from the at least one second output shaft.

According to an example, the first transmission unit and/or the second transmission unit is shiftable between different gear ratios.

Arranging the first transmission unit and/or the second transmission unit is shiftable between different gear ratios will provide a modular transmission platform which covers a wide specification of performance steps for different vehicles. In addition, such shiftable first and second transmission units will also provide a wide specification of performance steps in the vehicle, in which the modular transmission platform is arranged. The first and second transmission units may comprise gear wheels, chains or belts for transferring torque and gear ratio between the transmission shafts. Shifting gears, may be accomplished by means of a control device, which controls components necessary for gear shifting, such as actuators and shifting forks. The number of possible gear steps first and second transmission units may depend on needs and type of vehicle provided with the modular transmission platform.

According to an example, the second transmission shaft is configured to receive first and/or second transmission units of different configurations adapted for different gear ratios.

The second transmission shaft is a common component for the first and the second transmission units. The gear wheels, chain wheels or belt wheels may be arranged on the second transmission shaft in different positions depending on the configuration of the specified gear ratio for the first and the second transmission units. The second transmission shaft may be extended or shortened depending on the number of gear wheels, chain wheels or belt wheels to be arranged on the second transmission shaft. A large number of gear wheels, chain wheels or belt wheels may need a long second transmission shaft. A small number of gear wheels, chain wheels or belt wheels may need a short second transmission shaft. The gear wheel pairs may be arranged in modules, and each separate module of gear wheel pairs may be arranged in the first and/or the second shiftable transmission unit of the modular transmission platform. The second transmission shaft is configured to receive the gear wheel pairs arranged in modules. When the first and/or the second transmission unit is shiftable the modularity and adaptation of the modular transmission platform to different needs and to different types of vehicles increases. Depending on the specification of performance steps for the vehicle, the second shiftable transmission unit may be provided with a number of gear wheel pairs with different gear ratio.

According to an example, a power take off is connected to the at least one second output shaft.

The modular transmission platform allows the at least one second output shaft to be used for power take off functions without affecting the propulsion unit, which enables use of power take off functions while the vehicle is at standstill. Furthermore, by having two propulsion units, which both can provide propulsion torque on the second output shaft, each propulsion unit can be smaller and less powerful compared to when one single propulsion unit should provide all power for propulsion and auxiliary components etc.

The first and second shafts may be connected to a power take off at a front end of the first transmission shaft and/or at a front and/or rear end of the second transmission shaft. If two propulsion units are connected to the first transmission shaft, the may be controlled individually, without affecting each other. The second propulsion unit can provide power to power take offs during all driving situations, including starting from standstill, without affecting the propulsion of the vehicle or interrupting the modular transmission platform, which may be driven by the first propulsion unit. This may be specifically advantageous when the vehicle is operated in reverse. In such situation, the first propulsion unit, which may be a first electrical machine, may be operated to apply a torque in opposite (reverse) direction on the first transmission shaft and thereby on the output shaft. The power take off connected to the second shaft may, however, require to be driven in one specific direction, typically a forward direction. Thus, if the propulsion units were not arranged to be controlled independently of each other, the power take off could not be provided with power when the vehicle is reversing. The modular transmission platform according to the present disclosure thus facilitates and improves the operation of the vehicle, with regard to propulsion and driving of power take offs.

According to an example, an auxiliary output is connected to the at least one second output shaft.

The first and second transmission shafts may be connected to an auxiliary component via the auxiliary output at a front end of the first transmission shaft and/or at a front and/or rear end of the second transmission shaft. Such auxiliary component may be a compressor, a pump or similar. If two propulsion units are connected to the first transmission shaft, the may be controlled individually, without affecting each other. The second propulsion unit can provide power to an auxiliary component during all driving situations, including starting from standstill, without affecting the propulsion of the vehicle or interrupting the modular transmission platform, which may be driven by the first propulsion unit. This may be specifically advantageous when the vehicle is operated in reverse. In such situation, the first propulsion unit, which may be a first electrical machine, may be operated to apply a torque in opposite (reverse) direction on the first transmission shaft and thereby on the output shaft. The auxiliary component connected to the second transmission shaft may, however, require to be driven in one specific direction, typically a forward direction. Thus, if the propulsion units were not arranged to be controlled independently of each other, the power take off could not be provided with power when the vehicle is reversing. The modular transmission platform according to the present disclosure thus facilitates and improves the operation of the vehicle, with regard to propulsion and driving of auxiliary components.

According to an example, the at least one second output shaft is connected to the first transmission shaft.

The at least one second output shaft may be connected to front end of the first transmission shaft. The front end of the first transmission shaft may be provided with the at least one second output shaft when propulsion unit is not arranged at the front end of the first transmission shaft. Thus, the front end of the first transmission shaft may be configured with a second input shaft or a second output shaft. A possibility to configure the front end of the first transmission shaft with a propulsion unit, a power take off or an auxiliary equipment will increase the modularity and adaptation of the modular transmission platform to different needs and to different types of vehicles.

According to an example, the at least one second output shaft is connected to the second transmission shaft.

The at least one second transmission shaft may be connected to a front end of the second transmission shaft and/or to a rear end of the second transmission shaft. Thus, the second transmission shaft may be arranged with two second output shafts, one in each end of the second output shaft. The possibility to configure the front end and or the rear end of the second transmission shaft with a power take off and/or an auxiliary equipment will increase the modularity and adaptation of the modular transmission platform to different needs and to different types of vehicles.

According to an example, a retarder is connected to the third transmission shaft.

The retarder will brake the third transmission shaft and thus the output shaft, propeller shaft and thus the vehicle. The retarder is an auxiliary brake, which may complement wheel brakes of the vehicle, so that excessive wear of the wheel brakes is avoided. In order to reduce energy losses and to reduce the vehicle's energy consumption, the retarder may be disengaged from the third transmission shaft when the retarder is deactivated and does not have to brake the vehicle.

According to an example, the first, second and third transmission shafts are arranged in parallel to each other.

The parallel extension of the first, second and third transmission shafts to each other will create a compact modular transmission platform, which may be possible to arrange in a suitable position in the vehicle. In addition, it will be able to arrange the at least one propulsion unit in parallel with the first output shaft of the modular transmission platform. In front of the modular transmission platform a space is created when the at least one propulsion unit is arranged in a position between the modular transmission platform and the rear axle and in parallel with the first output shaft of the modular transmission platform.

According to the present disclosure, a powertrain for a vehicle is provided. The powertrain comprising the modular transmission platform disclosed herein.

Such a powertrain for a vehicle will have a high degree of freedom how to configurate the powertrain, which may depend on the end user requirements. Several propulsion units with different performance levels could be provided, depending on the end user requirements. The second output shaft could be located where a second propulsion unit may be located. The addition of a second propulsion unit, as could be the same as the first propulsion unit, will give a significant performance step in propulsion power. Also, if the propulsion units are electrical machines, the regeneration power will increase if two electrical machines are comprised in the powertrain. The two propulsion units may share the same rotation center, which enables connection and disconnection of the propulsion units from each other. This will create a multitasking powertrain. Since at least one shaft end of the first and second transmission shafts is not directly coupled to the wheels, there is a potential to add a power take off and/or an auxiliary drive for vehicle crucial components, such as compressors driven by the powertrain, to such shaft end. The third transmission shaft is connected to the wheels and therefore an additional endurance brake, such as a retarder, may be connected to the third transmission shaft, without complicating the modular build up of the powertrain. Furthermore it is possible to add additional gear steps for heavy applications in the first and/or the second shiftable transmission unit between the second and third transmission shaft. In order to increase startability demands of the vehicle, it is possible to add planetary gear sets to any of the first, second and third transmission shafts.

According to an example, at least one propulsion unit is connected to the at least one input shaft and a propeller shaft connected to the first output shaft, an wherein at least one drive shaft of a rear axle, which at least one drive shaft is connected to the propeller shaft, so that the propeller shaft extends between the modular transmission platform and the at least one drive shaft.

The powertrain in the vehicle transfers power from the propulsion unit to drive wheels of the vehicle. The vehicle may be a heavy vehicle, e.g. a truck or a bus. The vehicle may alternatively be a passenger car. The vehicle may be driven by a driver. The vehicle may be remotely operated or autonomously operated. The drive wheels may be arranged in a rear part of the vehicle or in a front part of the vehicle. All wheels of the vehicle may be drive wheels. The propulsion unit may comprise one or several electrical machines. Alternatively, the propulsion unit may be an internal combustion engine. It is also possible to combine one or several electrical machines with an internal combustion engine in the powertrain. Such combination may allow the electrical machines and the internal combustion engine to work independently of each other or to work in combination as a hybrid drive.

The propeller shaft is configured to transfer rotational motion and torque between the transmission and the at least one drive shaft of the rear axle. The propeller shaft is with a first end connected to a first output shaft of the transmission and with a second end connected to the at least one drive shaft. The second end of the propeller shaft may be connected to the at least one drive shaft via a differential gear, which is arranged in the rear axle. The differential gear comprises an input shaft, which is connected to the propeller shaft, and two output shafts, each connected to a drive shaft. Each drive shaft is connected to a drive wheel, for driving the vehicle. The at least one drive shaft is configured to transfer rotational motion and torque between the propeller shaft and the drive wheel. The propeller shaft may have an extension in the same direction as the extension of the output shaft of the transmission and the extension of the input shaft of the differential gear. However, the propeller shaft may have an extension in another direction than the extension of the output shaft of the transmission and the extension of the input shaft of the differential gear. The rear axle may have an extension from one rear drive wheel at one side of the vehicle to another drive wheel on the other side of the vehicle. The vehicle may comprise a frame. The powertrain may be connected or attached to the frame. Thus, the propulsion unit, transmission, and the rear axle may be connected or attached to the frame. The rear axle may be connected to the frame by means of a suspension, which allows the rear axle to move in a vertical direction in relation to the extension of the frame.

Vehicle components such as shafts, frames, and components in the powertrain will be arranged outside the created space for the energy storage units. Thus, by arranging the at least one propulsion unit in a position between the transmission and the rear axle in the longitudinal direction of the vehicle will create an essential space in front of the powertrain. Further, when arranging the powertrain rearwards in the vehicle in a direction towards rear axle of the vehicle, the created space in front of the powertrain will be even larger.

The input shaft of the transmission is connected to the at least one propulsion unit. The output shaft of the transmission is connected to the propeller shaft. The input shaft and the output shaft of the transmission have a parallel extension in relation to each other. The input shaft and the output shaft of the transmission extend in the same direction. When the transmission is arranged in the vehicle, the input shaft and the output shaft of the transmission extend in a direction towards the rear axle and the rear part of the vehicle. Connecting the at least one propulsion unit and the propeller shaft in parallel to the transmission will result in a compact powertrain and a large space in front of the transmission for accommodating energy storage units. The axis of the propeller shaft may be directed in different angels in relation to an axis of the output shaft of the transmission.

The propeller shaft is connected to the output shaft of the transmission. The input shaft and the output shaft of the transmission have a parallel extension in relation to each other. However, depending on the vehicle configuration the center axis of the propeller shaft may extend in an angle in relation to the center axis of the output shaft of the transmission.

The length of the powertrain, from the point of connection between the propeller shaft and the drive shaft of the rear axis, is the common extension of the propeller shaft and the transmission in the longitudinal direction of the vehicle. Thus, the length of the propeller shaft and the length or the longitudinal packaging volume of the transmission will define the extension of the powertrain in front of the rear axle. A short propeller shaft and/or a short or more compact modular transmission platform, will create a large space in front of the powertrain for accommodating energy storage units. Arranging the powertrain as far as possible towards the rear axle will create an even larger space in front of the powertrain for accommodating energy storage units.

According to an example, the at least one propulsion unit is arranged in a position between the modular transmission platform and the rear axle in a longitudinal direction of the vehicle.

In front of the transmission, and thus in front of the powertrain a space is created when the at least one propulsion unit is arranged in a position between the transmission and the rear axle. The definition of the longitudinal direction of the vehicle, is a direction from the front part of the vehicle to the rear part of the vehicle. The created space in front of the transmission, and thus in front of the powertrain, may accommodate energy storage units for storing electrical power. The created space may alternatively, or in combination, accommodate energy storage units for liquid fuel, such as diesel fuel or petrol. The created space for accommodating energy storage units increases the storage and the capacity of electrical power and/or liquid fuel for propulsion of the propulsion units, and thus increases the operation range of the vehicle. The created space in the vehicle may accommodate a large energy storage unit or a number of small energy storage units.

According to an example, the at least one propulsion unit is an electrical machine.

The powertrain may use only electrical machines as a propulsion unit. The propulsion unit may comprise a large electrical machine provided with enough torque and power for propelling the vehicle. Alternatively, a number of propulsion units may be arranged in the powertrain, comprising a number of small electrical machines, which together are provided with enough torque and power for propelling the vehicle. The storage and the capacity of electrical power for propulsion of the electrical machines will increase the operation range of the vehicle due to the larger accommodation capacity of the energy storage units.

According to an example, the powertrain comprises at least two propulsion units arranged in series with each other.

At least two propulsion units arranged in series with each other and arranged in a position between the modular transmission platform and the rear axle in a longitudinal direction of the vehicle. In front of the modular transmission platform, and thus in front of the powertrain a space is created. The created space in front of the modular transmission platform, and thus in front of the powertrain, may accommodate energy storage units for storing electrical power and liquid fuel, such as diesel fuel or petrol. Alternatively, connecting the propulsion units in series to each other, wherein the first propulsion unit is arranged in a position between the modular transmission platform and the rear axle, and the second propulsion unit is arranged in front of the modular transmission platform will also result in a compact powertrain. However, the space in front of the modular transmission platform for accommodating energy storage units will be reduced with such a configuration.

According to an example, the powertrain comprises at least two propulsion units, wherein the at least two propulsion units comprises at least one electrical machine and an internal combustion engine.

An electrical machine may be combined with an internal combustion engine in the powertrain. It is also possible to combine one or several electrical machines with an internal combustion engine in the powertrain. Such combination may allow the electrical machines and the internal combustion engine to work independently of each other or to work in combination as a hybrid drive. The electrical machine is connected to a first input shaft of the first transmission shaft of the modular transmission platform and the internal combustion engine is connected to a second input shaft of the first transmission shaft of the modular transmission platform. The storage and the capacity of electrical power and fluid fuel for propulsion of the electrical machines and the internal combustion engine will increase the operation range of the vehicle due to the larger accommodation capacity of the energy storage units in the created space in front of the powertrain.

According to an example, a first planetary gear is arranged between the propulsion unit and the at least one input shaft.

In order to increase startability demands of the vehicle, a first planetary gear is arranged between the propulsion unit and the at least one input shaft. Such first planetary gear may be shiftable.

According to an example, a second planetary gear is arranged between the propeller shaft and the first output shaft.

In order to further increase startability demands of the vehicle, a second planetary gear is arranged between the propeller shaft and the first output shaft. Such second planetary gear may be shiftable.

According to the present disclosure, a vehicle is provided. The vehicle, comprising the powertrain disclosed herein. A vehicle provided with such a powertrain will have an increased the operation range due to the extended storing capacity of electrical power and/or fuel in the space created in front of the powertrain in the vehicle.

According to an example, an energy storage unit is arranged in front of the powertrain in the vehicle. The created space in front of the powertrain in the vehicle will accommodate an energy storage unit, comprising stored energy depending on the type of propulsion unit.

The present disclosure will now, according to an example, be further illustrated with reference to the appended figures.

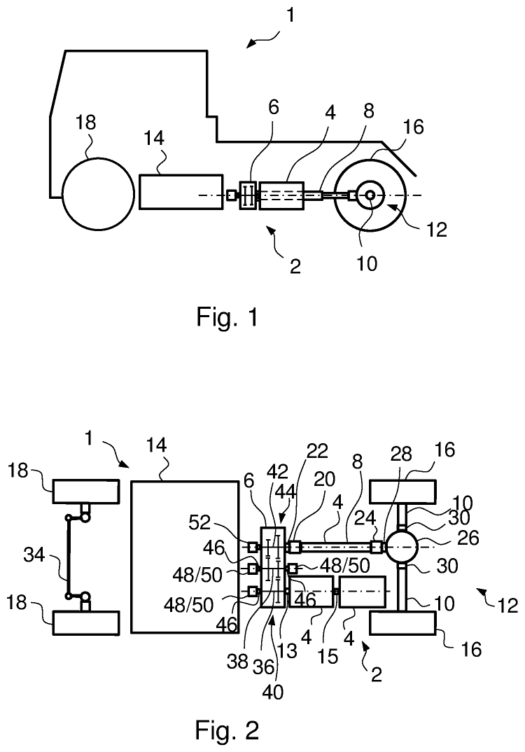

FIG. 1 schematically illustrates a side view of a vehicle 1 with a powertrain 2 according to an example. The powertrain 2 comprising a propulsion unit 4, a modular transmission platform 6 connected to the at least one propulsion unit 4 and a propeller shaft 8 connected to the modular transmission platform 6, and at least one drive shaft 10 of a rear axle 12. The at least one drive shaft 10 is connected to the propeller shaft 8, so that the propeller shaft 8 extends between the modular transmission platform 6 and the at least one drive shaft 10. The at least one propulsion unit 4 is arranged in a position between the modular transmission platform 6 and the rear axle 12 in a longitudinal direction of the vehicle 1. An energy storage unit 14 is arranged in front of the powertrain 2. The energy storage unit 14 is connected to the propulsion unit 4 and deliver power to the propulsion unit 4. A number of propulsion units 4 may be arranged in series. The vehicle 1 comprises rear drive wheels 16 and front wheels 18.

FIG. 2 schematically illustrates a view from above of a powertrain 2 according to an example. Two propulsion unit 4 are connected in series to the modular transmission platform 6. The modular transmission platform 6 may also be referred to as a transmission 6. The propulsion units 4 may be electrical machines, which provide torque and power for propelling the vehicle 1. According to an example, one propulsion unit 4 may be an electrical machine and the other propulsion unit 4 may be an internal combustion engine. The electrical machine and the internal combustion engine are arranged in a position between the modular transmission platform 6 and the rear axle 12. A first input shaft 13 of the modular transmission platform 6 is connected to a first propulsion unit 4. A second input shaft 15 of the modular transmission platform 6 is connected to a second propulsion unit 4. The second input shaft 15 may extend coaxial through and within the first propulsion unit 4 and the first input shaft 13. The propeller shaft 8 is with a first end 20 connected to a first output shaft 22 of the modular transmission platform 6 and with a second end 24 connected to the drive shafts 10 of the rear axle 12. The second end 24 of the propeller shaft 8 may be connected to the drive shafts 10 via a differential gear 26, which is arranged in the rear axle 12. The differential gear 26 comprises an input shaft 28, which is connected to the propeller shaft 8, and two output shafts 30, each connected to a drive shaft 10. Each drive shaft 10 is connected to a drive wheel 16, for driving the vehicle 1. An energy storage unit 14 is arranged in front of the modular transmission platform 6 of the powertrain 2. The front wheels 18 of the vehicle 1 are steerable by means of a linkage mechanism 32. The propulsion units 4 and the propeller shaft 8 are connected in parallel to the modular transmission platform 6. The axial extension of the powertrain 2 in the longitudinal direction of the vehicle 1, from the connection between the propeller shaft 8 and the drive shaft 10, corresponds to the common axial extension of the propeller shaft 8 and the modular transmission platform 6 in the longitudinal direction of the vehicle 1.

The modular transmission platform 6 comprises a first transmission shaft 36. The at least one input shaft 13 is connected to the first transmission shaft 36. The first transmission shaft 36 is connected to the propulsion units 4. A second transmission shaft 38 is rotatably connected to the first transmission shaft 36 via a first transmission unit 40. The first output shaft 22 is connected to a third transmission shaft 42. The third transmission shaft 42 is connected to the propeller shaft 8. The third transmission shaft 42 is rotatably connected to the second transmission shaft 38 via a second transmission unit 44. The first, second and third transmission shafts 36, 38, 42 are arranged in parallel to each other. The modular transmission platform 6 comprises at least one second output shaft 46, configured for providing torque to equipment connected to the at least one second output shaft 46. The equipment 48, 50 connected to the at least one second output 46 shaft may be a power take off 48 and/or an auxiliary output 50. An auxiliary component such as a compressor, a pump or similar (not shown) may be connected to the auxiliary output 50. According to an example, the at least one second output shaft 46 is connected to the first transmission shaft 36. According to a further example, the at least one second output shaft 46 is connected to the second transmission shaft 38. A retarder 52 is connected to the third transmission shaft 42. The retarder 52 is configured to brake the third transmission shaft 42 and thus the propeller shaft 8 and the vehicle 1. The retarder 52 is an auxiliary brake, which may complement wheel brakes (not shown) of the vehicle 1, so that excessive wear of the wheel brakes is avoided. The at least one input shaft 13 and the first output shaft 22 extend from the modular transmission platform 6 in the same direction. The at least one input shaft 13 and the first output shaft 22 extend from the modular transmission platform 6 in a direction towards the rear axle 12 of the vehicle 1.

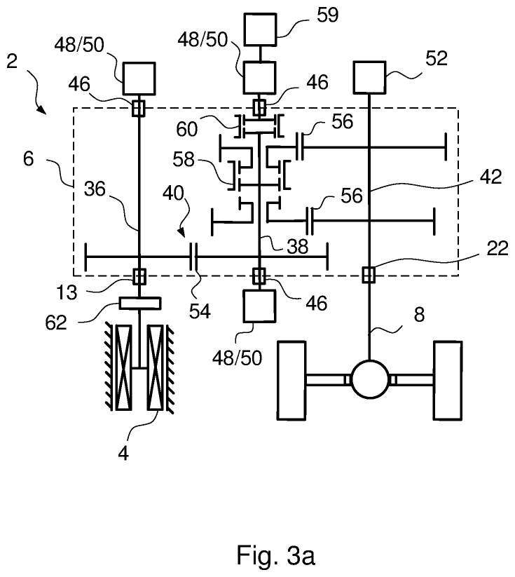

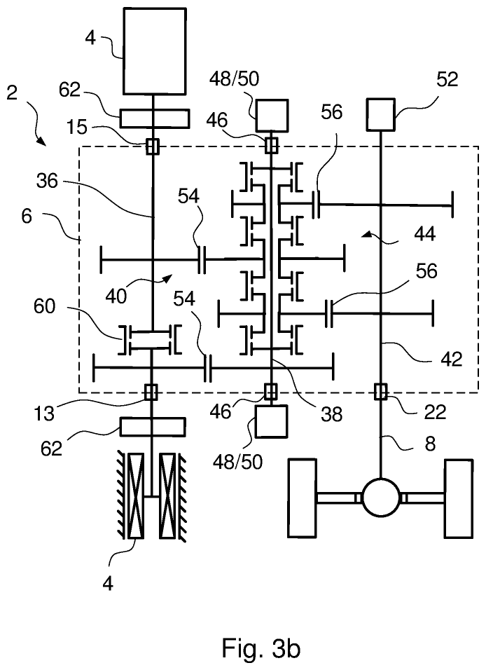

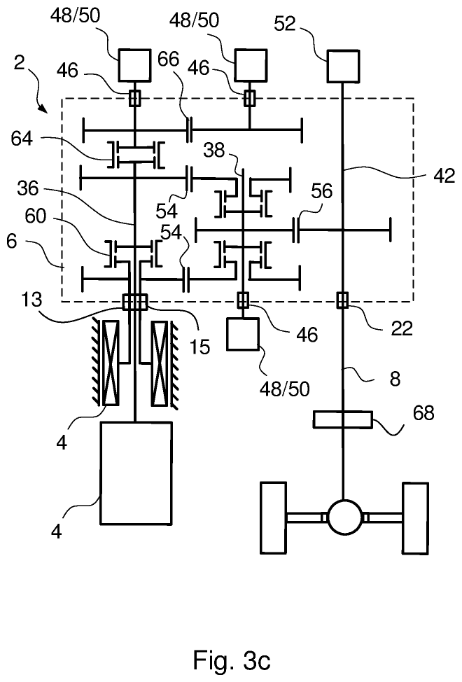

FIGS. 3a-3c schematically illustrate views from above of powertrains 2 according to different examples. The three transmission shafts 36, 38, 42 are arranged in parallel to each other in the modular transmission platform 6. The input shaft 13 of the first transmission shaft 36, is connected to the propulsion unit 4. The propulsion unit 4 in FIG. 3a is an electrical machine. The second transmission shaft 38 is rotatably connected to the first transmission shaft 36 via the first transmission unit 40. The first transmission unit 40 comprises a first gear wheel pair 54 with a fixed gear ratio. The third transmission shaft 42 is rotatably connected to the second transmission shaft 38 via the second transmission unit 44. The second transmission unit 44 comprises gear wheel pairs 56 arranged between the second and third transmission shafts 38, 42. The second transmission unit 44 comprises two second gear wheel pairs 56, with different gear ratios. An axially displaceable coupling sleeve 58 can be displaced between three positions. In a first position the axially displaceable coupling sleeve 58 connects one of the second gear wheel pairs 56 with the second transmission shaft 38, in a second position the axially displaceable coupling sleeve 58 connects the other second gear wheel pair 56 with the second transmission shaft 38 and in a third position the two second gear wheel pairs 56 are disconnected from the second transmission shaft 38. The axially displaceable coupling sleeve 58 can be provided with synchronization devices (not shown). The third transmission shaft 42 is provided with the first output shaft 22 configured to be connected to the propeller shaft 8. The modular transmission platform 6 comprises second output shafts 46 arranged on the first and second transmission shafts 36, 38, configured for providing torque to power take off 48 and/or auxiliary output 50. The auxiliary output 50 is configured to provide torque to auxiliary equipment 59 connected to the auxiliary output 50. The second output shaft 46 arranged on the second transmission shaft 42 may be connectable and disconnectable to and from the second transmission shaft 42 by means of a coupling unit 60. The retarder 52 can be connected directly to a front end of the third transmission shaft 42. A first planetary gear set 62 is arranged between the propulsion unit 4 and the first input shaft 13. The first planetary gear set 62 may be shiftable between different gear ratios.

The powertrain 2 illustrated in FIG. 3b is provided with two propulsion units 4 in series. The modular transmission platform 6 is provided with first and second input shafts 13, 15. The input shafts 13, 15 are connected to the first transmission shaft 36. The first input shaft 13 is connected to an electrical engine. The second input shaft 15 is connected to a propulsion unit 4, which may be an electric machine or any other type of propulsion unit 4, such as an internal combustion engine. First planetary gear sets 62 are arranged between each propulsion unit 4 and the respective input shaft 13, 15. A coupling unit 60 is arranged for connect and disconnect the two propulsion units 4 to end from each other. Two first gear wheel pairs 54 are arranged between the first and second transmission shafts 36, 38. Two second gear wheel pairs 56 are arranged between the second and third transmission shafts 38, 42. The gear wheels arranged on the second transmission shaft 38 may be connected to and disconnected from the second transmission shaft 38. Thus, both the first and second transmission units 40, 44 are shiftable, which results in a modular transmission platform 6 having a large number of different gear steps. Second output shafts 46 are connected to the second transmission shaft 38 configured for providing torque to power take off 48 and/or auxiliary output 50. The propeller shaft 8 is connected to the first output shaft 22 of the third transmission shaft 42. A retarder 52 is arranged on the third transmission shaft 42.

The powertrain illustrated in FIG. 3c is provided with two propulsion units 4 in series. The modular transmission platform 6 is provided with two input shafts 13, 15. The input shafts 13, 15 are connected to the first transmission shaft 36. The first input shaft 13 is connected to an electrical engine. The second input shaft 15 is connected to a propulsion unit 4, which may be an electric machine or any other type of propulsion unit 4, such as an internal combustion engine. The input shafts 13, 15 of the first transmission shaft 36 may extend coaxial through and within the propulsion unit 4, which is arranged closest to the modular transmission platform 6. A first coupling unit 60 is arranged for connecting and disconnecting one of the propulsion units 4 to and from the first transmission shaft 36. A coupling device 64 is arranged for connecting and disconnecting two second output shafts 46 to and from the first transmission shaft 36. The two second output shafts 46 are arranged on each gear wheel of a third gear wheel pair 66. Two first gear wheel pairs 54 are arranged between the first transmission shaft 36 and the second transmission shaft 38, which are selectively connectable and disconnectable to and from the second transmission shaft 38. A single second gear wheel pair 56 are arranged between the second transmission shaft 38 and the third transmission shaft 42. A second output shaft 46 is connected to the second transmission shaft 38 and configured for providing torque to power take off 48 and/or auxiliary output 50. The propeller shaft 8 is connected to the first output shaft 22 of the third transmission shaft 42. A retarder 52 is arranged on the third transmission shaft 42. A second planetary gear set 68 is arranged on the propeller shaft 8. The second planetary gear set 68 may be shiftable between different gear ratios.

The foregoing description of the examples has been furnished for illustrative and descriptive purposes. It is not intended to be exhaustive, or to limit the examples to the variants described. Many modifications and variations will obviously be apparent to one skilled in the art. The examples have been chosen and described in order to best explicate principles and practical applications, and to thereby enable one skilled in the art to understand the examples in terms of its various examples and with the various modifications that are applicable to its intended use. The components and features specified above may, within the framework of the examples, be combined between different examples specified.

1. A modular transmission platform for a vehicle, the modular transmission platform comprising:
a first transmission shaft with at least one input shaft configured to be connected to at least one propulsion unit;
a second transmission shaft, which is rotatably connected to the first transmission shaft via a first transmission unit; and
a third transmission shaft with a first output shaft configured to be connected to a propeller shaft;
wherein the third transmission shaft is rotatably connected to the second transmission shaft via a second transmission unit;
wherein the modular transmission platform comprises at least one second output shaft, configured for providing torque to equipment connected to the at least one second output shaft; and
wherein the at least one input shaft and the first output shaft extend from the modular transmission platform in the same direction.

2. The modular transmission platform according to claim 1, wherein the first transmission unit and/or the second transmission unit is shiftable between different gear ratios.

3. The modular transmission platform according to claim 1, wherein the second transmission shaft is configured to receive first and/or second transmission units of different configurations adapted for different gear ratios.

4. The modular transmission platform according to claim 1, wherein a retarder is connected to the third transmission shaft.

5. The modular transmission platform according to claim 1, wherein the first, second and third transmission shafts are arranged in parallel to each other.

6. A powertrain for a vehicle, wherein the powertrain comprising a modular transmission platform, said modular transmission platform comprising:
a first transmission shaft with at least one input shaft configured to be connected to at least one propulsion unit;
a second transmission shaft, which is rotatably connected to the first transmission shaft via a first transmission unit; and
a third transmission shaft with a first output shaft configured to be connected to a propeller shaft;
wherein the third transmission shaft is rotatably connected to the second transmission shaft via a second transmission unit;
wherein the modular transmission platform comprises at least one second output shaft, configured for providing torque to equipment connected to the at least one second output shaft; and
wherein the at least one input shaft and the first output shaft extend from the modular transmission platform in the same direction.

7. The powertrain according to claim 6, wherein at least one propulsion unit is connected to the at least one input shaft and a propeller shaft connected to the first output shaft, and wherein at least one drive shaft of a rear axle, which at least one drive shaft is connected to the propeller shaft, so that the propeller shaft extends between the modular transmission platform and the at least one drive shaft.

8. The powertrain according to claim 7, wherein the at least one propulsion unit is arranged in a position between the modular transmission platform and the rear axle in a longitudinal direction of the vehicle.

9. The powertrain according to claim 7, wherein the at least one propulsion unit is an electrical machine.

10. The powertrain according to claim 7, wherein the powertrain comprises at least two propulsion units arranged in series with each other.

11. The powertrain according to claim 7, wherein the powertrain comprises at least two propulsion units, wherein each of the at least two propulsion units comprises at least one electrical machine and an internal combustion engine.

12. The powertrain according to claim 7, wherein a first planetary gear set is arranged between the at least one propulsion unit and the at least one input shaft.

13. The powertrain according to claim 7, wherein a second planetary gear set is arranged between the propeller shaft and the first output shaft.

14. A vehicle, comprising a powertrain comprising a modular transmission platform, said modular transmission platform comprising:
a first transmission shaft with at least one input shaft configured to be connected to at least one propulsion unit;
a second transmission shaft, which is rotatably connected to the first transmission shaft via a first transmission unit; and
a third transmission shaft with a first output shaft configured to be connected to a propeller shaft;
wherein the third transmission shaft is rotatably connected to the second transmission shaft via a second transmission unit;
wherein the modular transmission platform comprises at least one second output shaft, configured for providing torque to equipment connected to the at least one second output shaft; and
wherein the at least one input shaft and the first output shaft extend from the modular transmission platform in the same direction.

15. The vehicle according to claim 14, wherein an energy storage unit is arranged in front of the powertrain in the vehicle.
